(19) United States
(12) Patent Application Publication
(10) Pub. No.: US 2004/0098512 A1
(43) Pub. Date: May 20, 2004

(54) NAPT gateway system with method capable of extending the number of connections

(75) Inventor: Jyun-Naih Lin, Taipei (TW)

Correspondence Address: BACON & THOMAS, PLLC, 625 SLATERS LANE, FOURTH FLOOR, ALEXANDRIA, VA, 22314

(73) Assignee: Institute for Information Industry, Taipei (TW)

(21) Appl. No.: 10/390,790

(22) Filed: Mar. 19, 2003

(30) Foreign Application Priority Data
Nov. 19, 2002 (TW) 91133759

(51) Int. Cl. G06F 15/16

(52) U.S. Cl. 709/249; 709/245

(57) ABSTRACT

NAPT gateway system with method for extending the number of connections are disclosed. The gateway is located between a private network and the Internet and has a plurality of NAPT tables. When receiving a packet transmitted from the private network to the Internet, the gateway takes the destination IP address of the packet as a hash key for corresponding to a NAPT table of the NAPT tables via a hash function. An item of the NAPT table that conforms to the packet is determined, and the source IP address and the source port of the packet are translated into the legal address of the NAPT gateway and the index of the item, respectively, based on the item.

### BACKGROUND OF THE INVENTION

1. Field of the Invention

The present invention relates to Network Address and Port Translation (NAPT) gateways technology and, more particularly, to NAPT gateway system with method capable of extending the number of connections.

2. Description of Related Art

Recently, available Internet Protocol (IP) addresses have found to be insufficient because the number of machines coupled to the Internet is increased dramatically. For solving this problem, conventionally, a NAPT gateway is provided as an interface between a private network and the Internet. Hence, a legal IP address can be shared by a plurality of machines coupled to the private network for sending packets by means of IP network address and port translation. FIG. 1 schematically illustrates a transmission of packets 11 from the first machine A1 (with IP address A1) located in a private network to the third machine D1 located in the Internet via a NAPT gateway C (with legal IP address C). The NAPT gateway C translates source address A1 of the packet 11 into the address C of the NAPT gateway C based on the NAPT rule as the packet 11 arrives at the NAPT gateway C. Also, source port number 1357 of the packet 11 is translated into an assigned port number 2345 of the NAPT gateway C. Thus, the packet 11 is sent out to its destination. Likewise, when machine A2 having an IP address of A2 coupled to the private network is desired to send a packet 12 to the machine D2 in the Internet via the NAPT gateway C, the NAPT gateway C translates source address A2 of the machine 12 into the address C of the NAPT gateway C based on the NAPT rule as the packet 12 arrives at the NAPT gateway C. Also, source port number 2468 of the packet 12 is translated into an assigned port number 6789 of the NAPT gateway C. Accordingly, the packet 12 is sent out to its destination. In such a manner, the purpose of sharing a common IP address at the NAPT gateway by a plurality of machines coupled to the private network can be achieved.

However, the conventional technique suffers from a disadvantage as described below. Because the length of the source port number or ICMP Identifier is two bytes, the maximum number of Transport Control Protocol (TCP), User Datagram Protocol (UDP), or Internet Control Message Protocol (ICMP) connections at the same time is restricted to 65,535. An additional connection is prohibited from being established if the number of connections has reached 65,535. Instead, one of the existing connections has to be released prior to establishing a new connection. Such limitation on the number of connections is not desirable. Therefore, it is desired to improve the conventional NAPT gateway system and method so as to mitigate and/or obviate the aforementioned problems.

### SUMMARY OF THE INVENTION

The object of the present invention is to provide a NAPT gateway system with a method for extending the number of connections available for machines coupled to the private network in accessing the Internet at the same time.

In one aspect of the present invention, there is provided a method used by a NAPT gateway for extending the number of connections. The gateway is located between a private network and the Internet and has a plurality of NAPT tables. Each NAPT table has a plurality of items. Each item is provided for storing a connection record of a flow. The method comprises the steps of: (A) when receiving an IP packet transmitted from the private network to the Internet, the gateway taking the destination IP address of the packet as a hash key for corresponding to a NAPT table of the NAPT tables via a hash function; (B) if an item of the NAPT table hashed conforms to the packet, translating the source IP address and the source port of the packet into the legal IP address of the NAPT gateway and the index of the item, respectively, based on the item; and (C) if no item of the NAPT table hashed conforms to the packet, finding an unused item in the NAPT table for storing necessary connection information of the packet and translating the source IP address and the source port of the packet into the IP legal address of the NAPT gateway and the index of the found item, respectively.

In another aspect of the present invention, there is provided a NAPT gateway system capable of extending the number of connections, which includes: a machine coupled to a private network; at least one machine coupled to the Internet; and a NAPT gateway located between the private network and the Internet for translating packets transmitted from the machine in the private network to be routed to the machine in the Internet. The NAPT gateway has a plurality of NAPT tables. Each NAPT table has a plurality of items. Each item is provided for storing a connection information of a flow. When receiving a packet transmitted from the private network to the Internet, the gateway takes the destination IP address of the packet as a hash key for corresponding to a NAPT table of the NAPT tables via a hash function, and finds an item of the NAPT table hashed conforming to the packet for translating the source IP address and the source port of the packet into the legal address of the NAPT gateway and the index of the found item as an assigned port number, respectively, based on the item.

Other destinations, advantages, and novel features of the invention will become more apparent from the detailed description when taken in conjunction with the accompanying drawings.

### BRIEF DESCRIPTION OF THE DRAWINGS

FIG. 1 schematically illustrates a transmission of packets from machines coupled to a private network to machines coupled to the Internet via a conventional NAPT gateway;

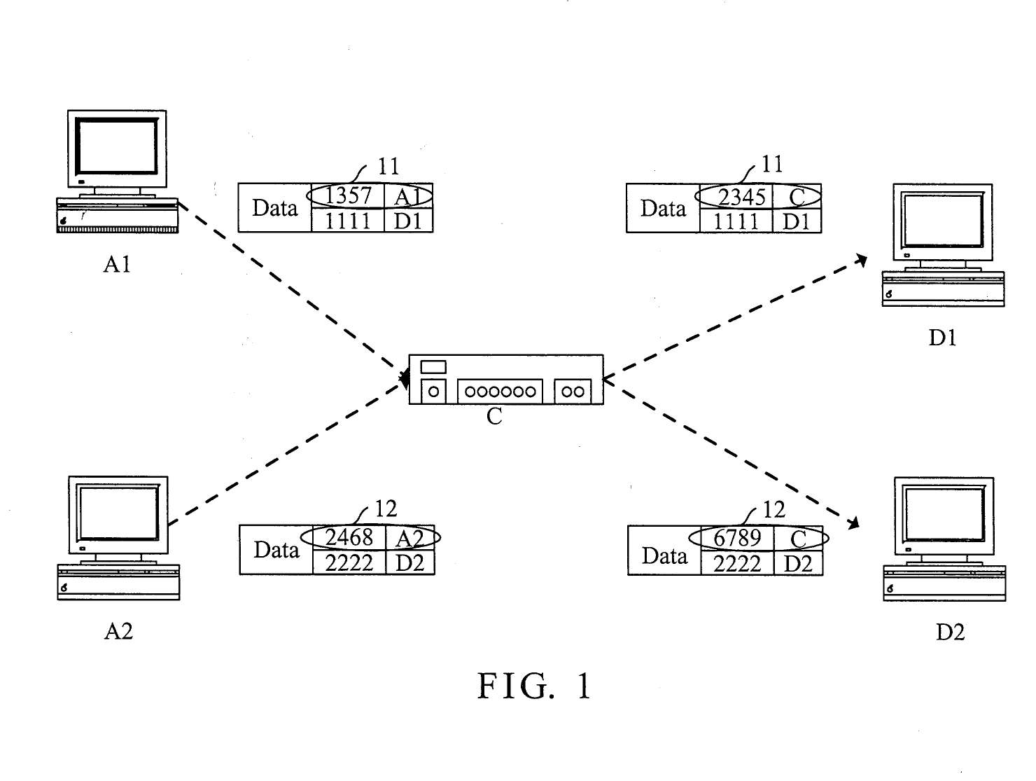

FIG. 2 schematically illustrates a transmission of packets from machines coupled to the private network to machines coupled to the Internet via a NAPT gateway according to the system of the present invention;

FIG. 3 is a flowchart illustrating a process of transmitting a packet from the private network to the Internet according to the method of the present invention; and

FIG. 4 is a flowchart illustrating a process of transmitting a packet from Internet to the private network according to the method of the present invention.

### DETAILED DESCRIPTION OF THE PREFERRED EMBODIMENT

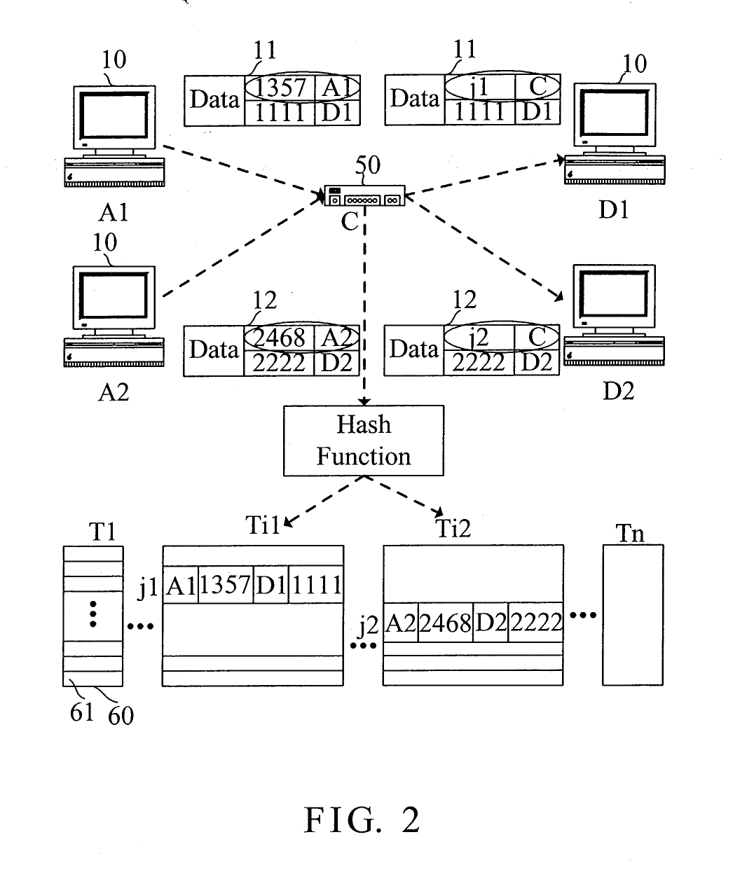

With reference to FIG. 2, there is shown a NAPT gateway system capable of extending the number of connections in accordance with the present invention. The system comprises at least one machine 10 (denoted as A1, A2 in this embodiment) coupled to a private network, a NAPT gateway 50, and at least one machine 10 (denoted as D1, D2 in this embodiment) coupled to the Internet. The machines A1, A2, D1, and D2 have IP addresses A1, A2, D1, and D2 respectively. The NAPT gateway 50 is served as an interface between the private network and the Internet for translating and routing packets transmitted between machines coupled to the private network and machines coupled to the Internet. Multiple NAPT tables 60 (T1˜Tn) are provided at the NAPT gateway 50. Each NAPT table 60 can have 65,535 items 61 at most. Each item 61 is used for save corresponding information of a connection of a flow, such as the source IP address, source port, destination IP address, and destination port of a packet arrived at the NAPT gateway 50 for NAPT translation.

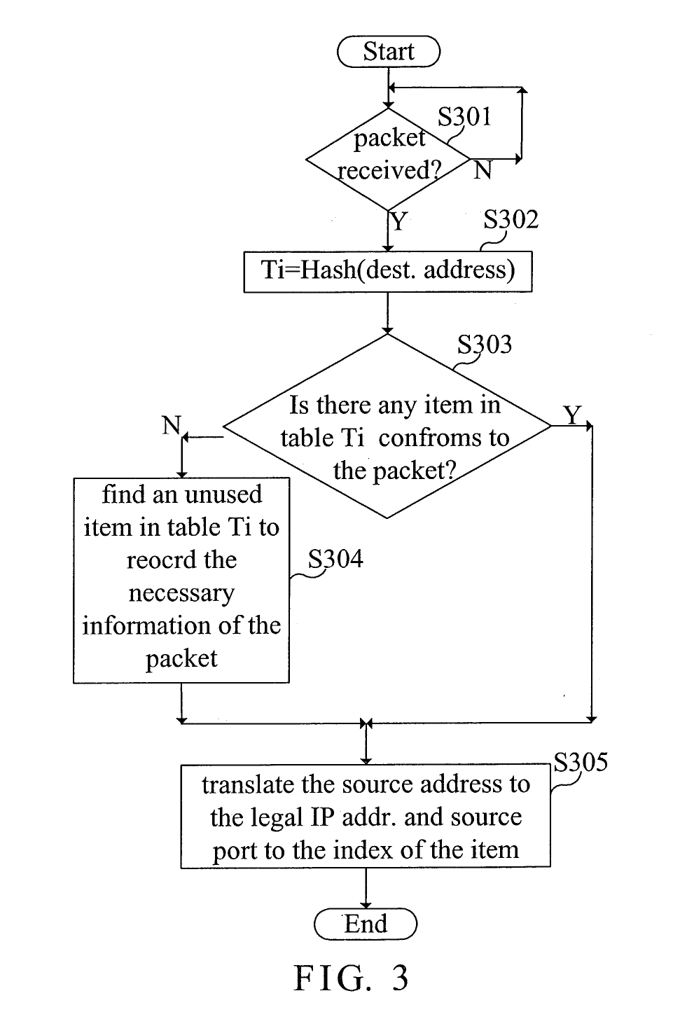

With reference to FIG. 3, there is shown a flowchart illustrating a process of transmitting packets from the private network to the Internet in accordance with the NAPT gateway method of the present invention. When a packet is received by the NAPT gateway 50 (step S301), the destination address D1 of the packet 11 is taken as a hash key to correspond to a NAPT table Ti1 in the plurality of NAPT tables 60 via a hash function (step S302).

In step S303, the source address A1, source port 1357, destination address D1, and destination port 1111 of the packet 11 are compared with corresponding items of the NAPT table Ti1. If they are not the same, it indicates that a connection for the packet 11 has not been established and a NAPT translation has not been performed in the NAPT gateway 50, and the process goes to step S304. Otherwise, the process jumps to step S305. In step S304, there is found an unused item having an index of j1 in the NAPT table Ti1 for storing the connection-related information including the source IP address A1, source port 1357, destination IP address D1, and destination port 1111 of the packet 11. In this embodiment, the translated source port number can be the index j1 of the item or the index j1 plus a predetermined value.

If step S303 determines that there is an item with record conforming to the packet 11, it indicates that a connection for the packet 11 has been established and a corresponding NAPT translation has been performed in the NAPT gateway 50. Thus, the found item in the table Ti1 can be directly used for performing NAPT translation.

In step S305, the source IP address A1 and source port 1357 of the packet 11 are translated into the legal IP address C of the NAPT gateway 50 and the index j1 of the found item in the NAPT table Ti1, respectively. Then, the packet is routed to the machine D1 thereafter.

Likewise, when the machine A2 in the private network transmits a packet to the machine D2 in the Internet, the gateway 50 takes the destination IP address D2 of the packet 12 as a hash key for corresponding to a NAPT table Ti2 in the plurality of NAPT tables via a hash function. If no item in the table Ti2 conforms to the packet 12, there is found an unused item having an index of j2 in the NAPT table Ti2 for storing the connection-related information of the packet 12. On the contrary, if there is an item with record conforming to the packet 12, the item is directly used for performing NAPT translation. Thereafter, the source IP address A2 and source port 2468 of the packet 12 are translated into the legal IP address C of the NAPT gateway 50 and the index j2 of the found item in the NAPT table Ti2, respectively. Then, the packet is routed to the machine D2 in the Internet.

It is possible that IP addresses D1, D2 of the machines D1, D2 correspond to the same NAPT table after conversion of hash function (i.e., Ti1=Ti2). Since the gateway 50 selects different items in the NAPT table for the packets transmitted from the machines A1 and A2, the translated source port numbers of the packets transmitted from the machines A1, A2 are also different. Hence, no confusion is encountered at the destination machine.

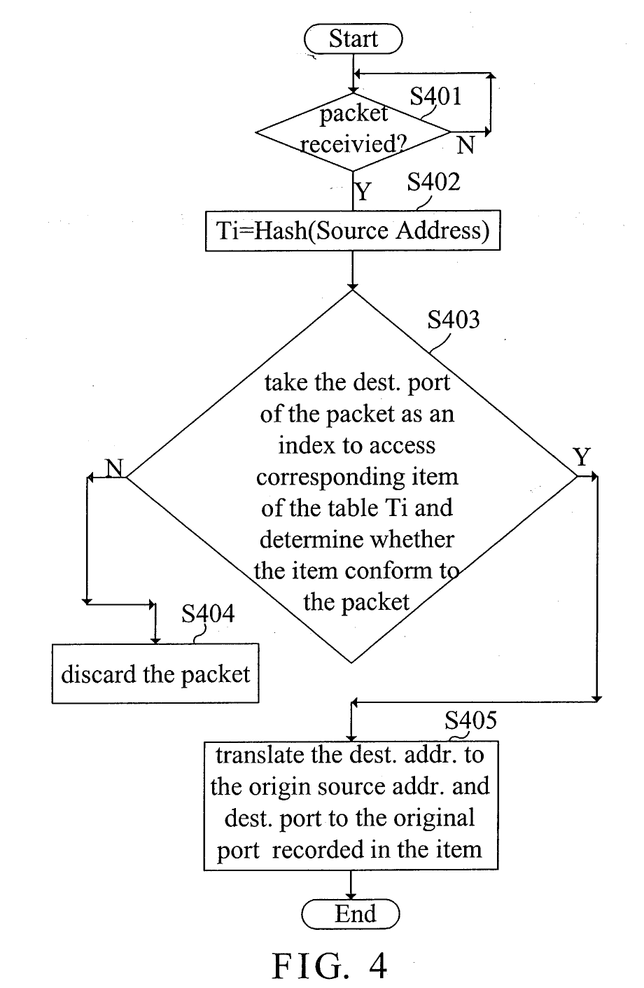

With reference to FIG. 4, there is shown a flowchart illustrating a process of transmitting packets from the Internet to the private network in accordance with the NAPT gateway method of the present invention. At first, when the gateway 50 receives a packet transmitted from the machine D1 or D2 in the Internet to the machine A1 or A2 in the privates network (step S401), the source address D1 or D2 of the packet is taken as a hash key for corresponding to a NAPT table Ti1 or Ti2 in the plurality of NAPT tables 60 via the same hash function as FIG. 3 (step S402). In step S403, the destination port number j1 or j2 of the packet is directly taken as an index to access a corresponding item j1 or j2 of the NAPT table Ti1 or Ti2, and the record of the item j1 or j2 is compared with that of the packet. If they are not the same, it indicates that there is an error with the received packet, and thus the packet is discarded (step 404).

In step S403, if the record of the item j1 or j2 conforms to the packet, the process jumps to step S405 for translating the destination IP address C and destination port j1 or j2 of the packet into the original source IP address A1 or A2 and the source port 1357 or 2468 of the item, respectively. As a result, the packet can be correctly routed to the machine A1 or A2 of the private network.

In view of the foregoing, it is known that, by utilizing the hash function technique, the number of connections can be extended to a maximum value of n*65,535 if, for example, the number of NAPT tables is n. Accordingly, the number of machines coupled to the private network for sharing a legal IP address will be increased dramatically, so as to fully satisfy the needs of the increased number of connections.

Although the present invention has been explained in relation to its preferred embodiment, it is to be understood that many other possible modifications and variations can be made without departing from the spirit and scope of the invention as hereinafter claimed.

What is claimed is:

1. A method used by a NAPT gateway for extending the number of connections, the gateway being located between a private network and the Internet and having a plurality of NAPT tables, each NAPT table having a plurality of items, each item being provided for storing a connection information of a flow, the method comprising the steps of:
(A) when receiving a packet transmitted from the private network to the Internet, the gateway taking the destination IP address of the packet as a hash key for corresponding to a NAPT table of the NAPT tables via a hash function;
(B) if an item of the NAPT table conforms to the packet, translating the source IP address and the source port of the packet into the legal IP address of the NAPT gateway and the index of the item, respectively, based on the item; and
(C) if no item of the NAPT table conforms to the packet, finding an unused item in the NAPT table for storing connection information of the packet and translating the source IP address and the source port of the packet into the legal IP address of the NAPT gateway and the index of the found item, respectively.

2. The method as claimed in claim 1, wherein, in steps (B) and (C), each of the items in the NAPT table is stored with connection information including source IP address, source port, destination IP address, and destination port of the packet.

3. The method as claimed in claim 2, wherein the index of the item is taken as the source port number after translation.

4. The method as claimed in claim 2, wherein the index of the item plus a constant is taken as the source port number after translation.

5. The method as claimed in claim 3, further comprising the steps of:
(D) when receiving a packet transmitted from the Internet to the private network, the gateway taking the source IP address of the packet as the hash key for corresponding to a NAPT table of the NAPT tables via the hash function; and
(E) taking the destination port number of the packet as an index for accessing a corresponding item of the NAPT table, and if the item conforms to the packet, translating the destination IP address and the destination port of the packet into the original source IP address and source port recorded in the item.

6. The method as claimed in claim 5, wherein, in step (E), the packet is discarded the item does not conform to the packet.

7. A NAPT gateway system capable of extending the number of connections comprising:
a machine coupled to a private network;
at least one machine coupled to the Internet; and
a NAPT gateway located between the private network and the Internet for translating packets transmitted from the machine in the private network to be routed to the machine in the Internet, the NAPT gateway having a plurality of NAPT tables, each NAPT table having a plurality of items, each item being provided for storing a connection information of a flow,
wherein, when receiving a packet transmitted from the private network to the Internet, the gateway takes the destination IP address of the packet as a hash key for corresponding to a NAPT table of the NAPT tables via a hash function, and finds an item of the NAPT table conforming to the packet for translating the source IP address and the source port of the packet into the legal address of the NAPT gateway and an assigned port number, respectively, based on the item.

8. The system as claimed in claim 7, wherein, if no item of the NAPT table conforms to the packet, an unused item in the NAPT table is found for storing connection information of the packet.

9. The system as claimed in claim 8, wherein each of the items in the NAPT table is stored with connection information including source IP address, source port, destination IP address, and destination port of the packet.

10. The system as claimed in claim 9, wherein the NAPT table takes the index of the item as the source port number after translation

11. The system as claimed in claim 9, wherein the NAPT table takes the index of the item plus a constant as the source port number after translation.

12. The system as claimed in claim 10, wherein, when receiving a packet transmitted from the Internet to the private network, the gateway takes the source IP address of the packet as the hash key for corresponding to a NAPT table of the NAPT tables via the hash function and then takes the destination port number of the packet as an index for accessing a corresponding item of the NAPT table, and if the item conforms to the packet, the destination IP address and the destination port of the packet are translated into the original source IP address and source port recorded in the item, otherwise the packet is discarded.
